(19) United States
(12) Patent Application Publication
(10) Pub. No.: US 2026/0129105 A1
(43) Pub. Date: May 7, 2026

(54) MULTIMODE EDGE TO CLOUD INFRASTRUCTURE FOR MONITORING AND MANAGING GPS DATA IN IOT NETWORKS

(71) Applicant: Cisco Technology, Inc., San Jose, CA (US)

(72) Inventors: Nikhil Mathur, Santa Clara, CA (US); Poornima Kandhade, Union City, CA (US); Lakshmi Thiyagarajan, Palo Alto, CA (US)

(21) Appl. No.: 18/938,068

(22) Filed: Nov. 5, 2024

(51) Int. Cl. H04L 67/563; H04L 43/0817; H04W 28/02; H04W 28/084

(52) U.S. Cl. CPC H04L 67/563; H04L 43/0817; H04W 28/0231; H04W 28/084

(57) ABSTRACT

In one aspect, a method includes determining, at an Internet of Things edge gateway, that a primary connection to a cloud service is not operational, the primary connection being a connection through which, during a normal mode of operation by the Internet of Things edge gateway, information collected by the Internet of Things edge gateway are sent to the cloud service for subsequent access. Upon determining that the primary connection is not operational, the method includes switching from the normal mode of operation to a local mode of operation at the Internet of Things edge gateway, wherein in the local mode of operation, the Internet of Things edge gateway enables access to a subset of the information via a secondary connection to a backup cloud service. Moreover, the method further includes sending the subset of the information to a secondary server over a secondary connection.

### BACKGROUND

Global Positioning System (GPS) supports mobile use cases in Internet of Things (IoT) systems. IoT edge gateways are deployed at the edge on assets (e.g., movable systems in field in which IoT devices are deployed, on buses, trucks, etc.). IoT edge gateways are capable of collecting GPS location and transmitting the same to cloud servers where this information can be accessed and managed by IoT system operators. As number of IoT devices grow, handling a flood of messages from a large number of edge IoT gateways can disrupt/take down the connection between IoT edge gateways and the cloud servers. Consequently, network operators may not be able to access the collected GPS data from the cloud servers.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example IoT system and corresponding cloud connectivity according to some aspects of the present disclosure.

FIG. 2 illustrates an example IoT system and corresponding ZTNA connectivity according to some aspects of the present disclosure.

FIG. 3 illustrates an example IoT environment with multi-modal edge to cloud infrastructure.

FIG. 4 illustrates a method for data access in a multi-modal edge to cloud infrastructure according to some aspects of the present disclosure.

FIG. 5 illustrates an example of a computing system according to some aspects of the present technology

### DETAILED DESCRIPTION

### OVERVIEW

Aspects of the present disclosure are directed to addressing disruptions in network connectivity between IoT edge gateways and cloud servers. In one aspect, a method includes determining, at an Internet of Things edge gateway, that a primary connection to a cloud service is not operational, the primary connection being a connection through which, during a normal mode of operation by the Internet of Things edge gateway, information collected by the Internet of Things edge gateway are sent to the cloud service for subsequent access. Upon determining that the primary connection is not operational, the method includes switching from the normal mode of operation to a local mode of operation at the Internet of Things edge gateway, wherein in the local mode of operation, the Internet of Things edge gateway enables access to a subset of the information via a secondary connection to a backup cloud service. Moreover, the method further includes sending the subset of the information to a secondary server over a secondary connection.

### EXAMPLE EMBODIMENTS

As noted above, Global Positioning System (GPS) supports mobile use cases in Internet of Things (IoT) systems. IoT devices may be deployed in any number of use cases. Such use cases include, but are not limited to, deployment in the fields such as oil fields, wind farms, power grids, etc. Other use cases can include autonomous driving applications, factory floors, transit systems, etc.

In order to convey underlying information collected/monitored by IoT devices, IoT edge gateways are deployed at the edge on assets (e.g., stationary or movable systems in field in which IoT devices are deployed, on buses, trucks, etc.). These IoT edge gateways may have software applications running thereon to collect various types of information including, but not limited to, GPS related information. GPS related information can include critical data such as live streaming information, cache buffers, sampling frequency updates, location information, geofence configurations, viewing alerts on violations, etc. Such information may be said to be critical, because they allow Operation Technology (OT) users (may also be referred to as system operators) to access and monitor IoT assets in the field.

OT users, through their respective terminals, retrieve these GPS related information from a cloud server to which IoT edge gateways are connected and periodically send collected GPS related information thereto. As the number of IoT devices and hence IoT edge gateways increase, the load on these cloud servers also increase. The increased load and/or other network connectivity issues may result in disruption to the connectivity of IoT edge gateways to the cloud servers, which in turn prevents OT users from accessing the GPS related data.

To address these disruptions, a User Interface (UI) portal and an edge application that can be both deployed in the cloud server and at the IoT edge gateways for monitoring and managing GPS related information are disclosed in this application. When the edge application is deployed to an IoT edge gateway, the edge application operates in the “cloud” mode if it is able to connect to the cloud server and exchange messages. Under circumstances where the edge application on an IoT edge gateway cannot connect to the cloud server, the edge application automatically enables the “local” mode which can provide the same user experience to OT users through a secondary connection to a Zero Trust Network Access (ZTNA) server that is activated as part of a ZTNA system to which the IoT edge gateway may be connected. This secondary connection can then provide the OT users with the access to the GPS related information as if the connection to the cloud server never went down in the first place.

In the local mode, the edge application on a given IoT edge gateway enables a “local cache” mode for location history when OT user accesses the edge application in the local mode through the secondary connection via ZTNA gateway. The special ‘local cache’ provides a moving window of location history and events for the duration of time user is logged into the edge application. Once connectivity is closed for local mode, the local-cache may be emptied.

Next, non-limiting examples of IoT systems and their connectivity to cloud servers and/or ZTNA systems will be described next.

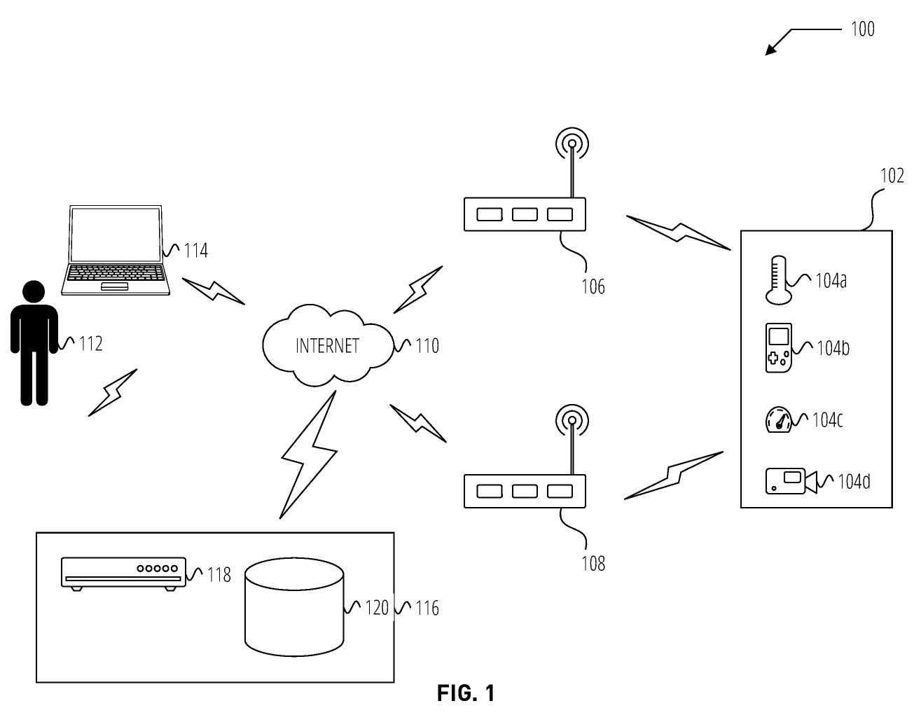

FIG. 1 illustrates an example IoT system and corresponding cloud connectivity according to some aspects of the present disclosure. System 100 includes IoT devices 102. Any number of IoT devices may be included as part of IoT devices 102. As a non-limiting example, IoT devices 102 can include IoT device 104a, IoT device 104b, IoT device 104c, and IoT device 104d (e.g., a thermometer, a remote sensor, a pressure gauge, a camera, etc. IoT devices 102 are not limited to having IoT device 104a, IoT device 104b, IoT device 104c, and IoT device 104d, and may include any number of IoT devices (e.g., hundreds to thousands of devices).

System 100 further includes one or more IoT edge gateways such as IoT edge gateway 106 and IoT edge gateway 108. An IoT edge gateway may also be referred to as an IoT edge router and may be any type of know or developed gateway, router, etc. An IoT edge gateway, among other functionalities, may provide computational power in edge computing scenarios. Edge computing distributes the load on a system by performing data processing at the data source, or “edge”, rather than relying on a central server for the bulk of the work.

An IoT gateway can enable IoT communication, usually device -to-device communications or device-to-cloud communications. An IoT gateway can be a hardware device having one or more memories with computer-readable instructions (corresponding to various relevant application software) stored thereon. The IoT gateway may have one or more processors configured to execute the computer-readable instructions to perform any number of associated functionalities. At its most basic level, the gateway facilitates the connections between different data sources and destinations (e.g., IoT devices to a cloud server, between IoT devices, IoT device to legacy or non-internet connected devices, etc.). Other, more complex, functionalities can include, but are not limited to, data pre-processing, cleansing, filtering, and optimization; data caching, buffering and streaming; some form of data aggregation; networking features and hosting live data; data visualization and data analytics via IoT gateway applications; short term data historian features; security and user access management; device configuration management; system diagnostics, etc.

The number of IoT edge gateways is not limited to two. Depending on the number of IoT devices 102, system 100 may include more or less IoT edge gateways.

System 100 further includes a public and/or private internet (e.g., Internet 110) through which one or more OT users such as OT user 112 using OT user terminal 114 may access cloud-based server(s) 116, IoT edge gateway 106, IoT edge gateway 108, and/or IoT devices 102.

Cloud-based server(s) 116 may include one or more servers such as server 118 and/or one or more databases such as database 120. Various types of data collected by IoT edge gateway 106 and/or IoT edge gateway 108 may be transmitted to server 118 over Internet 110 and stored therein to be subsequently accessed/managed via OT user terminal 114 by OT user 112.

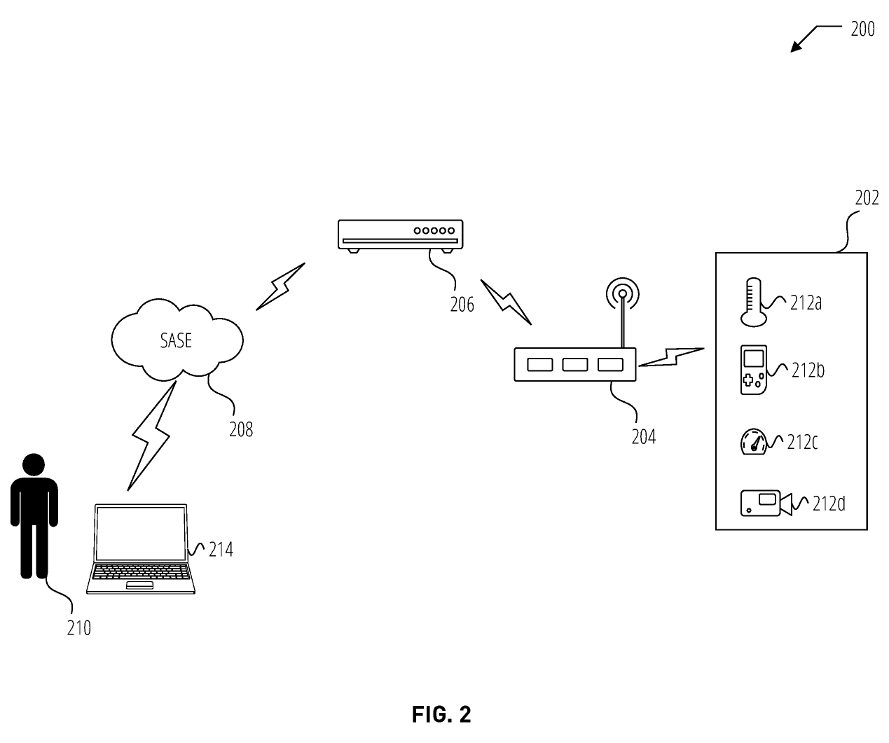

FIG. 2 illustrates an example IoT system and corresponding ZTNA connectivity according to some aspects of the present disclosure. As shown in FIG. 2, system 200 may include IoT devices 202 that may be the same as IoT devices 102 (e.g., IoT device 212a, IoT device 212b, IoT device 212c, and IoT device 212d may be the same as IoT device 104a, IoT device 104b, IoT device 104c, and IoT device 104d, respectively). Furthermore, IoT edge gateway 204 may be the same as IoT edge gateway 106 and/or IoT edge gateway 108. System 200 further includes one or more ZTNA gateways such as ZTNA gateway 206, Secure Access Service (SASE 208) and remote OT user 210 (remote OT user 210 may be the same as OT user 112) having OT user terminal 214 (may be the same as OT user terminal 114) for accessing SASE 208, ZTNA gateway 206, IoT edge gateway 204, and/or IoT devices 202.

In today’s interconnected global landscape, the need for remote access has become essential. Integrating Zero Trust Network Access (ZTNA) into operational technology (OT) environments (e.g., IoT environment) provides improvements over traditional methods like virtual private networks (VPNs) and dedicated cellular gateways. Within IoT environments, traditional methods require controlling who has access to what requires using jump servers to manage sessions and complex firewall rules that need to be frequently updated to prevent wide-open access.

ZTNA, with its least-privileged model, enhances security by allowing specific access based on user identity and necessity, minimizing the exposure of the entire network. ZTNA enhances security by adopting a ‘never trust, always verify’ approach, ensuring that remote users (e.g., remote OT user 210) can only gain access to applications and systems they are authorized to access. The model primarily works towards reducing the attack surface and minimizing the risk of wide open access to resources. Its application in the OT landscape addresses traditional challenges like remote site connectivity. Additionally, ZTNA facilitates continuous monitoring and adaptive risk assessment, empowering dynamic adjustments to security postures.

Using ZTNA, OT users connect to a ZTNA trust broker (e.g., SASE 208), which can be a cloud service responsible for authenticating and offering access to user terminals such as OT user terminal 214 access only to authorized devices and assets. SASE 208 may communicate with ZTNA gateway 206 deployed in the industrial network responsible for creating a communication path to the OT assets (e.g., IoT edge gateway 204 and/or IoT devices 202. With this architecture, assets can be hidden from discovery, and lateral movement is restricted. MFA, single sign-on (SSO), and security posture checks are enforced by the trust broker which also centralizes access policies for all assets across all sites.

In some examples, a ZTNA solution may be a distributed system. A distributed system can be made possible using one or more software agents (may be referred to as Secure Equipment Access (SEA) agent) on ZTNA gateways (e.g., routers and switches) such as ZTNA gateway 206.

SASE 208 may be a trust broker as indicated above and include one or more servers and cloud-based network resources configured to provide privilege-based access, enforce necessary authentication process (e.g., multi-factor authentication), check and monitor security postures of connected end devices such as remote OT user 210, IoT devices 102, IoT edge gateway 204, etc., and/or record, monitor and other manage (e.g., terminate) established communication sessions.

OT user terminal 214 may provide a clientless ZTNA access via a browser-based remote access using RDP, VNC, HTTP(S), SSH, Telnet, etc. In another example, an agent-based ZTNA access may be provided using native desktop applications.

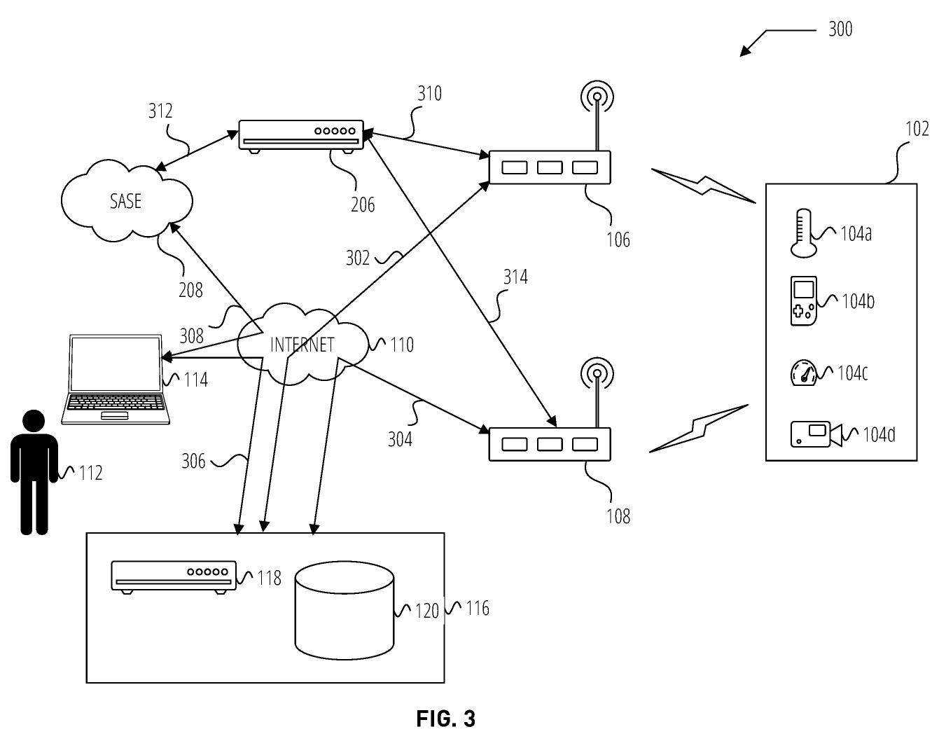

FIG. 3 illustrates an example IoT environment with multi-modal edge to cloud infrastructure according to some aspects of the present disclosure. Example system 300 is an overlay of system 100 and system 200 of FIGS. 1 and 2 with the addition of showing primary and secondary connections between IoT edge gateways and cloud-based server(s) 116 and ZTNA gateway 206/ SASE 208.

As shown in FIG. 3 and described above, in a normal mode of operation, IoT edge gateway 106 and IoT edge gateway 108 may be communicatively coupled to cloud-based server(s) 116 via a respective one of primary connection 302 and primary connection 304 as shown. With primary connection 302 and/or primary connection 304 active and operational, OT user 112, using OT user terminal 114 may access cloud-based server(s) 116 to access and manage IoT devices 102, IoT edge gateway 106, and/or IoT edge gateway 108.

As noted above, OT user 112 may utilize an application having a graphical user interface (portal). This GUI may be web browser-based or a native application installed on OT user terminal 114. OT user terminal 114 may be a desktop, a mobile phone, a handheld tablet, and/or any other known or to be developed device capable of connecting to Internet 110 and communicating with other devices over Internet 110. Furthermore, each one of IoT edge gateway 106 and IoT edge gateway 108 may have an application (may be referred to as edge application) installed thereon. Such edge application can allow for access to, monitoring, and management of GPS related data of IoT edge gateway 106 and/or IoT edge gateway 108.

In the normal mode of operation (i.e., when primary connection 302 and primary connection 304 between cloud-based server(s) 116 and respective one of IoT edge gateway 106 and IoT edge gateway 108 are alive, GPS related information are collected by edge applications installed on IoT edge gateway 106 and IoT edge gateway 108 and send over primary connection 302 and primary connection 304 to cloud-based server(s) 116. OT user 112, via OT user terminal 114, can access the GPS related information by connecting to cloud-based server(s) 116 using connection 306. At any given point in time, primary connection 302 and primary connection 304 may go down thus disrupting communications between cloud-based server(s) 116 and IoT edge gateway 106 and/or IoT edge gateway 108. This disruption can be due to any number of reasons including, but not limited to, overload of cloud-based server(s) 116, network disruption or maintenance, etc.

This disruption can be detected/identified using any known or to be developed method. For instance, and as a non-limiting example, IoT edge gateway 106 and/or IoT edge gateway 108 may periodically or continuously send collected data (e.g., GPS related data) to cloud-based server(s) 116. Lack of acknowledgement of data packets sent by IoT edge gateway 106 and/or IoT edge gateway 108 to cloud-based server(s) 116 (e.g., for a predetermined period of time) may be indicative of primary connection 302 and/or primary connection 304 being down.

In one example, until such determination is made (that one or more primary connections is down), edge applications on IoT edge gateway 106 and/or IoT edge gateway 108 may operate in a ‘normal’ mode. However, once a disruption in connectivity to cloud-based server(s) 116 is detected, such edge application(s) enable a ‘local’ mode of operation. In a ‘local’ mode of operation, IoT edge gateway 106 and/or IoT edge gateway 108 may send a critical subset of data collected (e.g., GPS related data) to a ZTNA server that may reside on ZTNA gateway 206 and/or SASE 208. GPS related data may be sent to a ZTNA server via secondary connections (e.g., secondary connection 310 and secondary connection 312 for IoT edge gateway 106 and secondary connection 312 and secondary connection 314 for IoT edge gateway 108). OT user 112 then accesses GPS related data from ZTNA server(s) on SASE 208 via 114 and connection 308. GPS related data, in the ‘local’ mode may either be collected and stored in a ‘local cache’ on respective ones of IoT edge gateway 106 and IoT edge gateway 108 or may alternatively be stored in a ‘local cache’ on one or more ZTNA servers on SASE 208.

In one example, GPS related data may be accessed via secondary connection 310, secondary connection 312, and secondary connection 314) so long as edge application(s) on IoT edge gateway 106 and/or IoT edge gateway 108 are unable to communicate with cloud-based server(s) 116. In one example, as soon as primary connection 302 and/or primary connection 304 is re-established, edge application(s) revert back to ‘normal’ mode and the 'local cache is emptied (deleted, flushed).

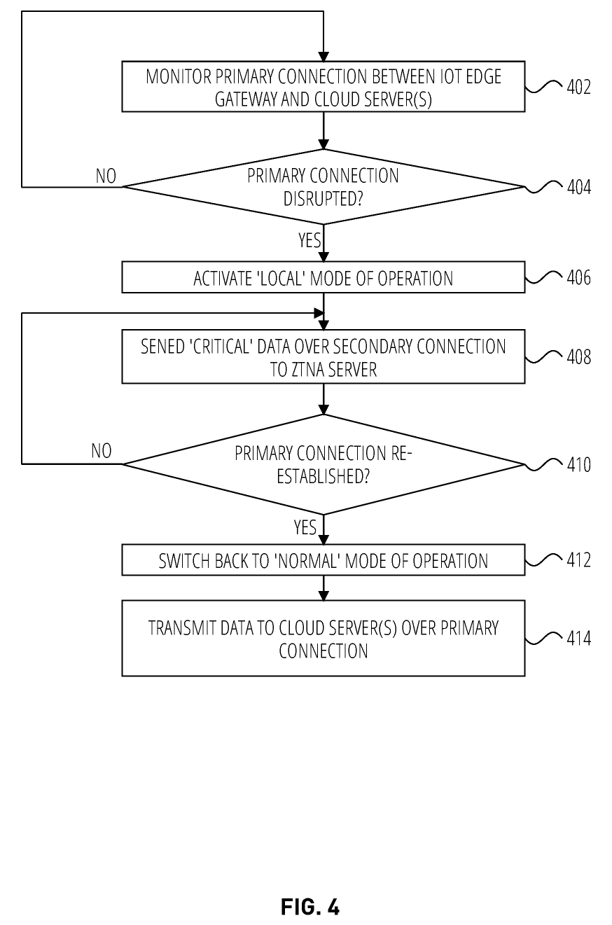

FIG. 4 illustrates a method for data access in a multi-modal edge to cloud infrastructure according to some aspects of the present disclosure. FIG. 4 will be described from the perspective of an IoT edge gateway, which can be any one of IoT edge gateway 106 and IoT edge gateway 108. For sake of simplifying a description of FIG. 4, the steps described herein will be described from the perspective of IoT edge gateway 106.

At block 402 (a block may also be considered a step of a process described in FIG. 4), 106 may be operating in a ‘normal’ mode whereby various types of data (including GPS related data) are collected and sent to cloud-based server(s) 116 (cloud service) to be accessed on-demand via OT user terminal 114. While operating in ‘normal’ mode, 106 may monitor its respective primary connection 302 to cloud-based server(s) 116.

At decision block 404, IoT edge gateway 106 may determine if primary connection 302 is disrupted (not operation or down). This determination may be made according to any known or to be developed method as described above. If IoT edge gateway 106 determines that primary connection is not disrupted (NO at decision block 404), the process reverts back to block 402 and processes at block 402 and decision block 404 may be repeated until IoT edge gateway 106 determines that primary connection 302 is down.

Once IoT edge gateway 106 determines that primary connection 302 is down, then at block 406, IoT edge gateway 106 may activate (switch to) operation in ‘local’ mode. As described above, operation in ‘local’ mode may be one in which IoT edge gateway 106 connects to ZTNA gateway 206 and/or a ZTNA server on SASE 208 (backup cloud service) over secondary connection 310 and secondary connection 312.

Once operation in ‘local’ mode is activated, at block 408, IoT edge gateway 106 may send (transmit) ‘critical' data over such secondary connection to ZTNA gateway 206 and/or a ZTNA server on SASE 208. ‘Critical' data may include GPS related data (subset of information otherwise collected and monitored by IoT edge gateway 106 during ‘normal’ mode of operation) as described above. In one example, this ‘critical' data may be stored in a ‘local cache’ as described above.

At decision block 410, IoT edge gateway 106 determines if primary connection 302 is re-established. If not, the process reverts back to block 408 and steps described at block 408 and decision block 410 are repeated until primary connection 302 is re-established.

Once IoT edge gateway 106 determines that 302 is re-established, then at block 412, IoT edge gateway 106 may re-activate (switch) back to ‘normal’ mode of operation. Thereafter, at block 414, IoT edge gateway 106 may start transmitting data back to cloud-based server(s) 116 over primary connection 302 again.

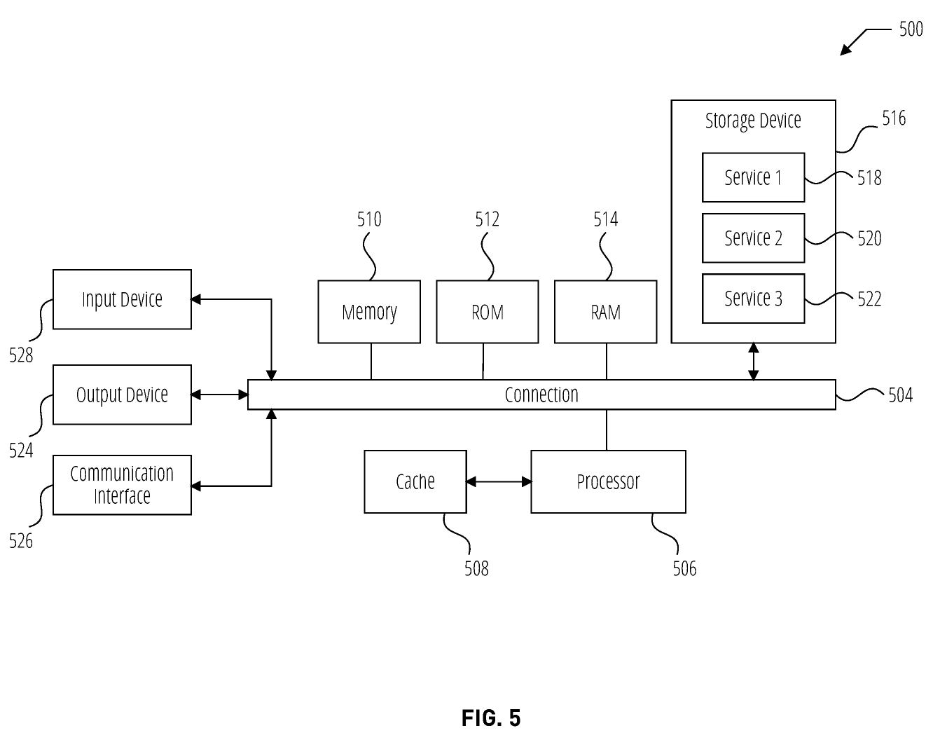

FIG. 5 illustrates an example of a computing system according to some aspects of the present technology. Example computing system 500 can be any of the network devices and components described above with reference to FIGS. 1-4 including, but not limited to, IoT edge gateway 106, IoT edge gateway 108, OT user terminal 114, server 118, database 120, IoT edge gateway 204, ZTNA gateway 206, one or more network components such as servers on SASE 208, OT user terminal 214, etc.

FIG. 5 shows an example of computing system 500, which can be for example any computing device making up a system network, or any component thereof in which the components of the system are in communication with each other using connection 504. connection 504 can be a physical connection via a bus, or a direct connection into processor 506, such as in a chipset architecture. Connection 504 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (central processing unit (CPU) or processor) such as processor 506 and connection 504 that couples various system components including memory 510, read-only memory (e.g., ROM 512), and random access memory (e.g., RAM 514) to processor 506. Computing system 500 can include a cache 508 of memory 510 (may be a high-speed memory) connected directly with, in close proximity to, or integrated as part of processor 506.

Processor 506 can include any general purpose processor and a hardware service or software service, such as service 1518, service 2520, and service 3522 stored in storage device 516, configured to control processor 506 as well as a special-purpose processor where software instructions are incorporated into the actual processor design. Processor 506 may essentially be a completely self-contained computing system, containing multiple cores or processors, a bus, memory controller, cache, etc. A multi-core processor may be symmetric or asymmetric.

To enable user interaction, computing system 500 includes an input device 528, which can represent any number of input mechanisms, such as a microphone for speech, a touch-sensitive screen for gesture or graphical input, keyboard, mouse, motion input, speech, etc. Computing system 500 can also include output device 524, which can be one or more of a number of output mechanisms known to those of skill in the art. In some instances, multimodal systems can enable a user to provide multiple types of input/output to communicate with computing system 500. Computing system 500 can include communication interface 526, which can generally govern and manage the user input and system output. There is no restriction on operating on any particular hardware arrangement, and therefore the basic features here may easily be substituted for improved hardware or firmware arrangements as they are developed.

Storage device 516 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Storage device 516 can include software services, servers, services, etc., that when the code that defines such software is executed by the processor 506, it causes the system to perform a function. In some embodiments, a hardware service that performs a particular function can include the software component stored in a computer-readable medium in connection with the hardware components, such as processor 506, connection 504, output device 524, etc., to carry out the function.

### Various aspects of the present disclosure include:

In one aspect, a method includes determining, at an Internet of Things edge gateway, that a primary connection to a cloud service is not operational, the primary connection being a connection through which, during a normal mode of operation by the Internet of Things edge gateway, information collected by the Internet of Things edge gateway are sent to the cloud service for subsequent access. Upon determining that the primary connection is not operational, the method includes switching from the normal mode of operation to a local mode of operation at the Internet of Things edge gateway, wherein in the local mode of operation, the Internet of Things edge gateway enables access to a subset of the information via a secondary connection to a backup cloud service. Moreover, the method further includes sending the subset of the information to a secondary server over a secondary connection.

In another aspect, the method further includes determining that the primary connection is operational again; and switching from the local mode of operation back to the normal mode of operation.

In another aspect, the method further includes deleting a local cache in which the subset of the information is stored for access during the local mode of operation.

In another aspect, the secondary connection is a secure connection.

In another aspect, the backup cloud service is a zero-trust network access cloud service.

In another aspect, in the local mode of operation, the subset of the information are stored in a local cache on at least one of the Internet of Things edge gateway or a server associated with the zero-trust network access cloud service.

In another aspect, the information include global positioning related data for the Internet of Things edge gateway.

In one aspect, a network gateway includes one or more memories having computer-readable instructions stored therein; and one or more processors. The one or more processors are configured to execute the computer-readable instructions to determine that a primary connection to a cloud service is not operational, the primary connection being a connection through which, during a normal mode of operation by the network gateway, information collected by the network gateway are sent to the cloud service for subsequent access; upon determining that the primary connection is not operational, switch from the normal mode of operation to a local mode of operation at the network gateway, wherein in the local mode of operation, the network gateway enables access to a subset of the information via a secondary connection to a backup cloud service; and send the subset of the information to a secondary server over a secondary connection.

In another aspect, the network gateway is an Internet of Things edge gateway.

In another aspect, the Internet of Things edge gateway is deployed on one or more assets that periodically move between different geographical locations.

In another aspect, the one or more processors are further configured to execute the computer-readable instructions to determine that the primary connection is operational again; and switch from the local mode of operation back to the normal mode of operation.

In another aspect, the one or more processors are further configured to execute the computer-readable instructions to deleting a local cache in which the subset of the information is stored for access during the local mode of operation.

In another aspect, the secondary connection is a secure connection and the backup cloud service is a zero-trust network access cloud service.

In another aspect, the information include global positioning related data for the Internet of Things edge gateway.

In one aspect, one or more non-transitory computer-readable media include computer-readable instructions, which when executed by one or more processors on an Internet of Things edge gateway, cause the Internet of Things edge gateway to determine that a primary connection to a cloud service is not operational, the primary connection being a connection through which, during a normal mode of operation by the Internet of Things edge gateway, information collected by the Internet of Things edge gateway are sent to the cloud service for subsequent access; upon determining that the primary connection is not operational, switch from the normal mode of operation to a local mode of operation at the Internet of Things edge gateway, wherein in the local mode of operation, the Internet of Things edge gateway enables access to a subset of the information via a secondary connection to a backup cloud service; and send the subset of the information to a secondary server over a secondary connection.

In another aspect, execution of the computer-readable instructions further cause the one or more processors to determine that the primary connection is operational again; and switch from the local mode of operation back to the normal mode of operation.

In another aspect, execution of the computer-readable instructions further cause the one or more processors to delete a local cache in which the subset of the information is stored for access during the local mode of operation.

In another aspect, the secondary connection is a secure connection and the backup cloud service is a zero-trust network access cloud service.

In another aspect, in the local mode of operation, the subset of the information are stored in a local cache on at least one of the Internet of Things edge gateway or a server associated with the zero-trust network access cloud service.

In another aspect, the information include global positioning related data for the Internet of Things edge gateway.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an Internet of things (IOT) network.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

For clarity of explanation, in some instances, the various examples can be presented as individual functional blocks comprising devices, device components, steps or routines in a method embodied in software, or combinations of hardware and software.

In some examples, the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware, and/or software, and can take various form factors. Some examples of such form factors include general-purpose computing devices such as servers, rack mount devices, desktop computers, laptop computers, and so on, or general-purpose mobile computing devices, such as tablet computers, smartphones, personal digital assistants, wearable devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting "at least one of" refers to at least one of a set and indicates that one member of the set or multiple members of the set satisfy the claim. For example, claim language reciting “at least one of A and B” means A, B, or A and B.

What is claimed is:

1. A method comprising:
determining, at an Internet of Things edge gateway, that a primary connection to a cloud service is not operational, the primary connection being a connection through which, during a normal mode of operation by the Internet of Things edge gateway, information collected by the Internet of Things edge gateway are sent to the cloud service for subsequent access;
upon determining that the primary connection is not operational, switching from the normal mode of operation to a local mode of operation at the Internet of Things edge gateway, wherein in the local mode of operation, the Internet of Things edge gateway enables access to a subset of the information via a secondary connection to a backup cloud service; and
sending the subset of the information to a secondary server over a secondary connection.

2. The method of claim 1, further comprising:
determining that the primary connection is operational again; and
switching from the local mode of operation back to the normal mode of operation.

3. The method of claim 2, further comprising:
deleting a local cache in which the subset of the information is stored for access during the local mode of operation.

4. The method of claim 1, wherein the secondary connection is a secure connection.

5. The method of claim 1, wherein the backup cloud service is a zero-trust network access cloud service.

6. The method of claim 5, wherein, in the local mode of operation, the subset of the information are stored in a local cache on at least one of the Internet of Things edge gateway or a server associated with the zero-trust network access cloud service.

7. The method of claim 1, wherein the information include global positioning related data for the Internet of Things edge gateway.

8. A network gateway, comprising:
one or more memories having computer-readable instructions stored therein; and
one or more processors configured to execute the computer-readable instructions to:
determine that a primary connection to a cloud service is not operational, the primary connection being a connection through which, during a normal mode of operation by the network gateway, information collected by the network gateway are sent to the cloud service for subsequent access;
upon determining that the primary connection is not operational, switch from the normal mode of operation to a local mode of operation at the network gateway, wherein in the local mode of operation, the network gateway enables access to a subset of the information via a secondary connection to a backup cloud service; and
send the subset of the information to a secondary server over a secondary connection.

9. The network gateway of claim 8, wherein the network gateway is an Internet of Things edge gateway.

10. The network gateway of claim 9, wherein the Internet of Things edge gateway is deployed on one or more assets that periodically move between different geographical locations.

11. The network gateway of claim 9, wherein the one or more processors are further configured to execute the computer-readable instructions to:
determine that the primary connection is operational again; and
switch from the local mode of operation back to the normal mode of operation.

12. The network gateway of claim 11, wherein the one or more processors are further configured to execute the computer-readable instructions to deleting a local cache in which the subset of the information is stored for access during the local mode of operation.

13. The network gateway of claim 9, wherein the secondary connection is a secure connection and the backup cloud service is a zero-trust network access cloud service.

14. The network gateway of claim 9, wherein the information include global positioning related data for the Internet of Things edge gateway.

15. One or more non-transitory computer-readable media comprising computer-readable instructions, which when executed by one or more processors on an Internet of Things edge gateway, cause the Internet of Things edge gateway to:
determine that a primary connection to a cloud service is not operational, the primary connection being a connection through which, during a normal mode of operation by the Internet of Things edge gateway, information collected by the Internet of Things edge gateway are sent to the cloud service for subsequent access;
upon determining that the primary connection is not operational, switch from the normal mode of operation to a local mode of operation at the Internet of Things edge gateway, wherein in the local mode of operation, the Internet of Things edge gateway enables access to a subset of the information via a secondary connection to a backup cloud service; and
send the subset of the information to a secondary server over a secondary connection.

16. The one or more non-transitory computer-readable media of claim 15, wherein execution of the computer-readable instructions further cause the one or more processors to:
determine that the primary connection is operational again; and
switch from the local mode of operation back to the normal mode of operation.

17. The one or more non-transitory computer-readable media of claim 15, wherein execution of the computer-readable instructions further cause the one or more processors to delete a local cache in which the subset of the information is stored for access during the local mode of operation.

18. The one or more non-transitory computer-readable media of claim 15, wherein the secondary connection is a secure connection and the backup cloud service is a zero-trust network access cloud service.

19. The one or more non-transitory computer-readable media of claim 18, wherein, in the local mode of operation, the subset of the information are stored in a local cache on at least one of the Internet of Things edge gateway or a server associated with the zero-trust network access cloud service.

20. The one or more non-transitory computer-readable media of claim 15, wherein the information include global positioning related data for the Internet of Things edge gateway.
